(19) United States
(12) Patent Application Publication
(10) Pub. No.: US 2026/0307647 A1
(43) Pub. Date: Oct. 8, 2026

(54) MITIGATION OF VEHICLE POWERTRAIN DAMAGE DURING WATER FORDING

(71) Applicant: TOYOTA MOTOR ENGINEERING & MANUFACTURING NORTH AMERICA, INC., Plano, TX (US)

(72) Inventors: Benjamin M. Geller, Ann Arbor, MI (US); Masayuki Baba, Ann Arbor, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 19/170,275

(22) Filed: Apr. 4, 2025

(51) Int. Cl. B60W 20/50; B60W 10/06; B60W 10/26; B60W 10/30

(52) U.S. Cl. CPC B60W 20/50; B60W 10/06; B60W 10/26; B60W 10/30; B60W 2400/00; B60W 2556/50; B60W 2710/0683; B60W 2710/242

(57) ABSTRACT

Mitigation of powertrain damage in vehicles due to liquid intrusion during water fording such as, for example, wading or crossing is provided by the disclosed systems and methods. To achieve mitigation, the system begins by first initiating a battery cooling fan or engine piston that generates a positive pressure in the vehicle exhaust, in response to receipt of an activation signal. Air from the battery pack housing or engine is then exhausted in order to prevent water ingress. The system then maintains operation of the fan speed or piston until the vehicle exits the water fording event.

### TECHNICAL FIELD

The subject matter described herein relates generally to vehicle powertrains and, more particularly, mitigation of powertrain damage when the vehicle undergoes water fording (e.g., wading/crossing).

### BACKGROUND

For hybrid vehicles that have air-cooled batteries, there are two primary risks when considering deep water fording (e.g., crossing a river). One is liquid intrusion into the high voltage battery pack, while the other is liquid intrusion into the engine.

### SUMMARY

In view of the foregoing, the various embodiments described herein provide systems and methods for mitigating powertrain damage in a vehicle due to liquid intrusion during water fording such as, for example, wading or crossing. A generalized method of the present disclosure begins by first initiating an operational speed of a battery cooling fan that generates a positive pressure within the battery pack housing of a vehicle, in response to receipt of an activation signal. Air from the battery pack housing is then exhausted in order to prevent water ingress into the battery pack. The system then maintains the battery cooling fan speed for a predetermined duration or until the vehicle exits the water fording event.

A generalized system of the present disclosure includes a battery pack housing configured to enclose a battery pack. A battery cooling fan is fluidly coupled to the battery pack housing. At least one sensor is configured to detect a water fording event. A controller is operatively connected to the battery cooling fan and the sensor. The controller is configured to, in response to an activation signal, initiate an operational speed of the battery cooling fan to generate a positive pressure within the battery pack housing of the vehicle. The controller then causes air to exhaust from the battery pack housing to prevent water ingress into the battery pack. The system then maintains the battery cooling fan speed for a predetermined duration or until the vehicle exits the water fording event.

In yet other embodiments, a vehicle is described herein which includes a battery pack housing configured to enclose a battery pack, a battery cooling fan fluidly coupled to the battery pack housing and a controller operatively connected to the battery cooling fan. The controller is configured to, in response to an activation signal, initiate an operational speed of a battery cooling fan to generate a positive pressure within a battery pack housing of the vehicle. The controller then exhausts air from the battery pack housing to prevent water ingress into the battery pack, and maintains the battery cooling fan speed for a predetermined duration or until the vehicle exits the water fording event. Note the pressure generated may be in addition to or in replacement of the cooling function of the fan. For example, if the fan needs to be used to cool the battery, and the water fording occurs, the fan may increase its speed/pressure or the system may determine the current fan pressure is sufficient.

Other embodiments of the present disclosure provide methods for mitigating powertrain damage in vehicles due to liquid intrusion during water fording. In response to an activation signal, a battery cooling fan or engine piston is initiated to create pressure in an exhaust of the vehicle to prevent water ingress. Operation of the battery cooling fan or engine piston is maintained until the vehicle exits the water fording event.

Yet another embodiment of the present disclosure provides a system for mitigating powertrain damage in a vehicle due to liquid intrusion during water fording. The system includes an engine comprising a piston and a controller operatively connected to the engine. The controller is configured to, in response to an activation signal, initiate the piston to pump air that creates pressure in an exhaust of the vehicle to prevent water ingress, and maintain the exhaust pressure until the vehicle exits the water fording event.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a diagrammatic illustration of a system for mitigating powertrain damage in accordance with at least one embodiment of the present disclosure.

FIG. 2A is a simplified illustration of vehicle system 100 useful to illustrate the basic principles of the present disclosure.

FIG. 2B is a simplified illustration of vehicle system 100 that illustrates advantages of various embodiments of the present disclosure.

FIG. 3 is a process flow chart of a method to mitigate powertrain damage in vehicles, according to certain illustrative embodiments of the present disclosure.

FIG. 4 is a flow chart of a method for mitigating powertrain damage in a vehicle due to liquid intrusion during water fording, according to certain illustrative embodiments of the present disclosure.

FIG. 5 is a schematic diagram of a processor circuit, in accordance with at least one embodiment of the present disclosure.

### DETAILED DESCRIPTION

The present disclosure is generally directed to systems and methods for mitigating powertrain damage in vehicles due to liquid intrusion during water fording. In one example, for hybrid vehicles that have air-cooled batteries, there are two primary risks when considering deep water fording (e.g., crossing a river). One is liquid intrusion into the high voltage (“HV”) battery pack, while the other is liquid intrusion into the engine (e.g., intake, exhaust, cylinder, etc.).

The present disclosure describes various systems to either manually or automatically activate control features to mitigate liquid intrusion into these powertrain systems. Many OEM's produce HV batteries that are liquid cooled. This design inherently reduces risk of water intrusion. However, air-cooled HV batteries are still used by some OEM as reduced cost products. In such systems, the air pathways for cooling create risk for water intrusion. To aid in mitigating this liquid intrusion, measures such as increasing the battery cooling fan speed could be applied, as described herein. This would create a positive pressure inside of the battery pack and exhaust area and can effectively reduce water from damaging components.

In a hybrid vehicle, the engine is typically allowed to stop/turn off when traveling at a low speed (EV driving). Water crossing is also typically a low-speed scene such as this. When the engine is turned off, water may more easily be able to enter the engine via the exhaust, other conduits, etc. To mitigate this intrusion, certain embodiments of the present disclosure provide a control mode that forces the engine to turn on and continue running until water intrusion is no longer a threat.

In other vehicles, drivers may have the ability to manually turn the engine on themselves (such as in a manual, M, S, sport mode, etc.). However, those drivers are not able to prescribe an appropriate amount of engine power to create backpressure in the engine, and they are not able to manually control the battery fan or internal battery pressure. Thus, in certain embodiments of the present disclosure, the system enables such a control to either be enabled by the driver directly (such as a switch/button or other trigger mechanism) or automatically (such as by GPS when identifying a route that crosses through water or by sensors that detect high water is being entered). As a result, any damage or failure due to water intrusion is mitigated.

Embodiment of the present disclosure may be implemented for a variety of vehicles such as on- and off-road vehicles that are comprised of hybrid electric powertrains to avoid damage of customer's vehicle powertrain components due to water crossing. Additionally, the features described herein may improve/reduce the burden on vehicle design complexity by enabling placement of exhaust, etc. in a more convenient location that would have previously incurred water intrusion risk. Embodiments of the present disclosure may additionally provide a reduction in unit design considerations for water intrusion at interfaces and seals due to this mitigation, although implementation would need to include long-term considerations of adding more positive-pressure operation of the engine and battery fan, or valve to bypass from engine exhaust to battery intake, etc. as will be understood by those ordinarily skilled in the art having the benefit of this disclosure.

The systems described herein may be implemented as a process at least partially implemented on a display, and operated by a control process executing on a processor that accepts user inputs from a suitable user-interface and other control devices, and that is in communication with one or more modules and remote processors. In that regard, the control process performs certain specific operations in response to different inputs or selections made at different times, and/or in response to real-time or near-real-time user inputs.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. It is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

These descriptions are provided for exemplary purposes, and should not be considered to limit the scope of the systems described herein. Certain features may be added, removed, or modified without departing from the spirit of the claimed subject matter.

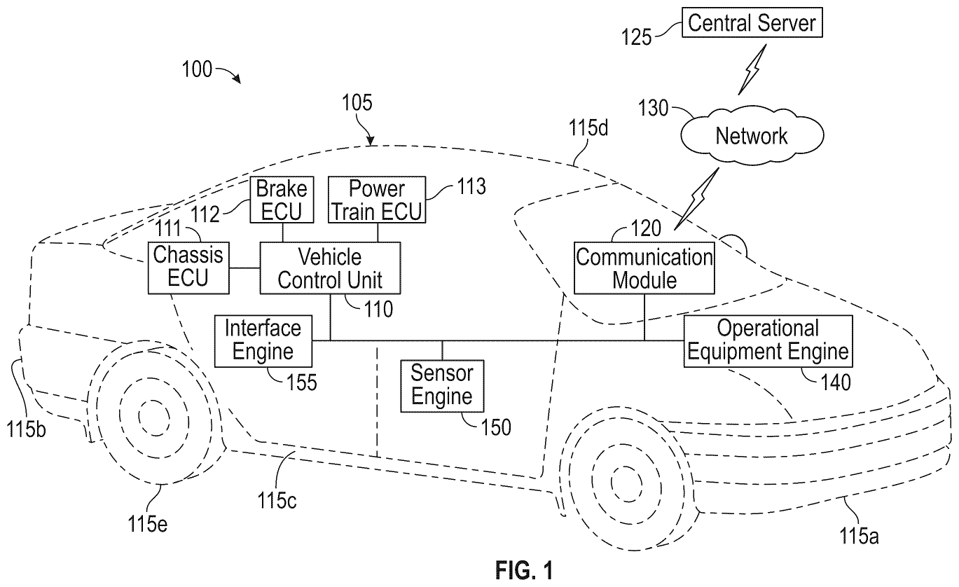

FIG. 1 is a diagrammatic illustration of a system for mitigating powertrain damage in accordance with at least one embodiment of the present disclosure. In this example, the system is referred to by the reference numeral 100 and includes a vehicle 105, such as a car, and a vehicle control unit 110 located on the vehicle 105. The vehicle 105 may include a front portion 115a (including a front bumper), a rear portion 115b (including a rear bumper), a right side portion 115c (including a right front quarter panel, a right front door, a right rear door, and a right rear quarter panel), a left side portion 115d (including a left front quarter panel, a left front door, a left rear door, and a left rear quarter panel), and wheels 115e.

A communication module 120 is operably coupled to, and adapted to be in communication with, the vehicle control unit 110. The communication module 120 is adapted to communicate wirelessly with a central server 125 via a network 130 (e.g., a 3G network, a 4G network, a 5G network, a Wi-Fi network, or the like). The central server 125 may provide information and services including but not limited to include location, mapping, route or path, and topography information. Further, communication module 120 may communicate with other computer systems using near-field communication or some other communication technique. However, that computer systems may also communicate with system 100 over network 130 in certain other embodiments.

An operational equipment engine 140 is operably coupled to, and adapted to be in communication with, the vehicle control unit 110 and power train ECU 113 which is utilized to perform the techniques described herein. A sensor engine 150 is operably coupled to, and adapted to be in communication with, the vehicle control unit 110.

An interface engine 155 is operably coupled to, and adapted to be in communication with, the vehicle control unit 110. In addition to, or instead of, being operably coupled to, and adapted to be in communication with, the vehicle control unit 110, the communication module 120, the operational equipment engine 140, the sensor engine 150, and/or the interface engine 155 may be operably coupled to, and adapted to be in communication with, another of the components via wired or wireless communication (e.g., via an in-vehicle network). In some examples, the vehicle control unit 110 is adapted to communicate with the communication module 120, the operational equipment engine 140, the sensor engine 150, and the interface engine 155 to at least partially control the interaction of data with and between the various components of EV system 100.

The term “engine” is meant herein to refer to an agent, instrument, or combination of either, or both, agents and instruments that may be associated to serve a purpose or accomplish a task—agents and instruments may include sensors, actuators, switches, relays, power plants, system wiring, computers, components of computers, programmable logic devices, microprocessors, software, software routines, software modules, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with any or all of the vehicle control unit 110, the communication module 120, the network 130, or a central server 125.

In this example, the vehicle 105 also includes a chassis electronic control unit (ECU) 111 which controls elements of the vehicle's suspension system, a brake ECU 112 which controls the braking system or elements thereof, a power train ECU 113 (variously known as an engine ECU, power plant ECU, motor ECU, transmission ECU or PCU) that controls elements of the motor and drivetrain, and sensor engine 150. Power train ECU may include its own controller/vehicle control system communicably coupled to the powertrain elements including, for example, the vehicle battery and related components and electric motor. Alternatively, vehicle control unit 110 may also be utilized from this functionality.

A reader of ordinary skill in the art will understand that other components or arrangements of components may be found in a vehicle 105, and that the same general principles apply to electric vehicles, internal combustion vehicles, and hybrid vehicles. For example, a power train ECU 113 may control both motor and transmission components. Alternatively, a separate motor ECU and transmission ECU may exist, or some functions of a motor ECU or transmission ECU may be performed by the VCU 110.

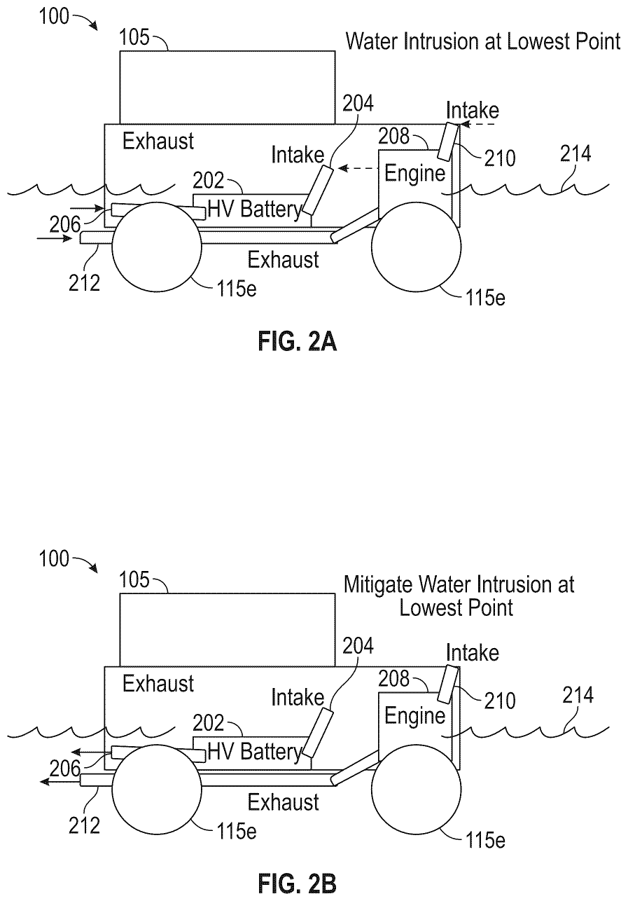

FIG. 2A is a simplified illustration of vehicle system 100 useful to illustrate the basic principles of the present disclosure. Vehicle 105 includes a high voltage battery pack 202 having an intake conduit 204 and exhaust conduit 206. Although not shown, battery pack 202 includes a cooling fan to cool mattery pack 202. Vehicle 105 also includes an engine 208, also having an intake conduit 210 and exhaust conduit 212. FIG. 2A shows the problem with conventional vehicle designs during a water fording event. As can be seen, vehicle 105 in FIG. 2A is partially submerged in water 214. As vehicle 105 enters water 214, water is shown intruding into exhaust conduits 206 and 212.

FIG. 2B is a simplified illustration of vehicle system 100 that illustrates advantages of various embodiments of the present disclosure. Vehicle 105 again includes a high voltage battery pack 202 having an intake conduit 204 and exhaust conduit 206. Although not shown, battery pack 202 includes a cooling fan to cool mattery pack 202. Vehicle 105 also includes an engine 208, also having an intake conduit 210 and exhaust conduit 212. In addition, battery pack 202 and engine 208 is communicably coupled to power train ECU 113 of FIG. 1. Thus, when vehicle 105 is at least partially submerged in water 214, an activation signal may be triggered. This activation signal may be generated automatically based on a sensor input (from sensor engine 150) which has detected vehicle 105 has entered water 215. Alternatively, the activation signal may be manually generated by a vehicle occupant engaging some trigger mechanism. In yet another alternative embodiment, the water fording event may be detected based on routing data obtained from a global positioning system (GPS) onboard vehicle 105 or accessed via network 130. The GPS data is used to predict when and where along the vehicle route that vehicle 105 will encounter water sufficiently deep to result in a water fording event.

Once the activation signal is generated, system 100 initiates the cooling fan of battery pack 202 or a piston of engine 208 to create positive pressure inside exhaust conduits 206/212 to prevent ingress of water 214 therein. System 100 maintains operation of the cooling fan or piston until vehicle 105 exits the water fording event.

More specifically, in the first instance when system 100 initiates the cooling fan of battery pack 202, this in turn creates a positive pressure within the battery pack housing. As the positive pressure builds, it is exhausted from conduit 206 at a pressure sufficient to prevent the ingress of water into conduit 206 and the housing of battery pack 202. System 100 can maintain the speed of the cooling fan, or adjust the speed as necessary, for a predetermined duration or until vehicle 105 exits the water fording event.

In an alternative embodiment, conduit 206 may be controlled a valve or shutter which may be opened or closed by system 100 to supplement management of the air pressure in created by the fan/blower in the battery pack 202. In some embodiments, the valve control of system 100 may be optional and could additionally assist in mitigating water intrusion beyond the fan alone.

Alternatively, when system 100 initiates one or more pistons of engine 208, this in turn creates positive pressure within engine 208. As that pressure builds, it is exhausted from conduit 212 at a pressure sufficient to prevent the ingress of water into conduit 212 and the housing of engine 208. In certain embodiments utilizing combustion engines, the engines may be started to thereby activate piston(s) to create the positive pressure via emissions. In alternative embodiments, however, system 100 has the ability to “motor” the engine. Motoring the engine refers to spinning the engine by an electric motor (e.g., starter motor, motor/generator, etc.) to create pressure in exhaust 212 via the piston pumping air-without the need to provide spark or fuel (combustion), thus avoiding fuel consumption or emissions in this state.

In certain illustrative embodiments, system 100 may determine the amount of positive pressure necessary to create sufficient pressure to prevent water intrusion in a variety of ways. For example, sensor engine 150, via sensors onboard vehicle 105 or on network 130 (e.g., satellite imagery, sensor infrastructure near vehicle 105, etc.), may be used to determine the amount of water 214 or the depth thereof, to thereby determine what amount of pressure exiting exhaust 206 or 212 is necessary. As such, system 100 can control the motoring speed or fan speed (and duration) necessary to match and/or overcome the expected incoming pressure of the forded water 214.

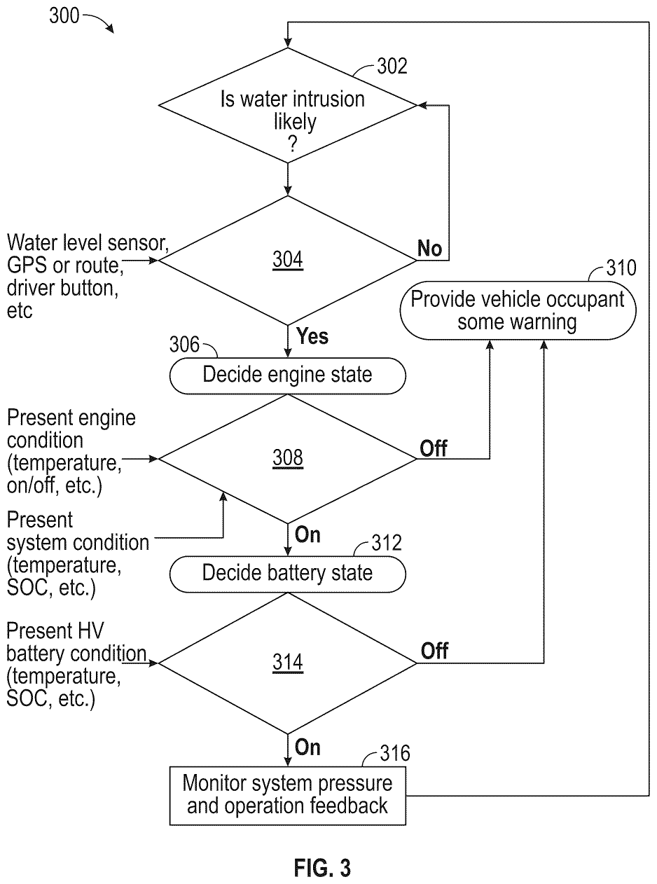

FIG. 3 is a process flow chart of a method to mitigate powertrain damage in vehicles, according to certain illustrative embodiments of the present disclosure. At block 302, system 100 (e.g., via VCU 110) determines if water intrusion is likely. Such a determination can be based upon, for example, data from water level sensors located on vehicle 105 or elsewhere on network 130, GPS or route data, vehicle occupant triggers/button, etc. If system 100 determines a “NO” at block 304, system 100 continues to iteratively wait until circumstances are present where water intrusion is likely. At block 304, if system 100 determines a “YES”, the method proceeds to block 306 where the status of engine 208 is determine. Here, system 100 considers a variety of information including, for example, data on the present engine condition such as temperature, on/off status of engine, etc. In addition, system 100 consider data related to the present system condition such as, for example, temperature of system components, state of charge (SOC) of the battery 202, etc.

Using this data, system 100 determines the engine status at decision block 308. If the determination is “OFF”, the method proceeds to block 310 where system 100 can then provide some warning to vehicle occupants that there is a risk to water intrusion into the exhaust of engine 202. Such a warning can take a variety of forms including, for example, audible, tactile or visual warnings via in-vehicle display, mobile devices, seats, steering wheel, heads-up display, etc. If the determination at block 308 is “ON”, system 100 proceeds to block 312 to decide the status of battery 202.

At decision block 314, system 100 considers a variety of data including, for example, the present condition of battery 202 such as, for example, temperature, SOC, etc. If the determination is “OFF,” the method proceeds to block 310 and issues a warning to vehicle occupants there is a risk of water intrusion into exhaust 206 of battery 202. If the determination is “ON,” system 100 then monitors the pressure and operational feedback data of engine 208 and battery 202 (block 316) to ensure the pressure generated by battery 202 and/or engine 208 is sufficient to prevent water intrusion into exhausts 206 and/or 212. Such pressure is maintained until the vehicle exists the water fording event and/or it is manually deactivated. The process then iteratively loops back to block 302.

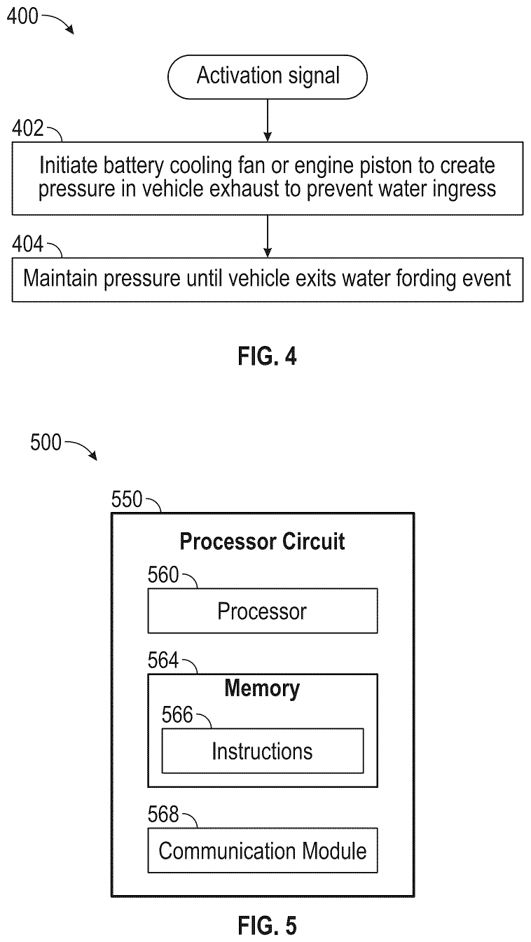

FIG. 4 is a flow chart of a method for mitigating powertrain damage in a vehicle due to liquid intrusion during water fording, according to certain illustrative embodiments of the present disclosure. Method 400 begins via receipt of an activation signal as described herein. At block 402, in response to the activation signal, the system initiates a battery cooling fan or engine piston to create pressure in an exhaust of the vehicle to prevent water ingress. At block 404, the system maintains operation of the battery cooling fan or engine piston until the vehicle exits the water fording event.

FIG. 5 is a schematic diagram of a processor circuit 550, in accordance with at least one embodiment of the present disclosure. The processor circuit 550 may be implemented in the system 100 or other devices or workstations (e.g., third-party workstations, network routers, etc.), or on a cloud processor or other remote processing unit, as necessary to implement the methods described herein. As shown, the processor circuit 550 may include a processor 560, a memory 564 having instructions 566 thereon, and a communication module 568. These elements may be in direct or indirect communication with each other, for example via one or more buses.

The processor 560 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 560 may also comprise another hardware device, a firmware device, or any combination thereof configured to perform the operations described herein. The processor 560 may also be implemented as a combination of computing devices, e.g., a combination of a DSP and a microprocessor, a plurality of microprocessors, one or more microprocessors in conjunction with a DSP core, or any other such configuration.

The memory 564 may include a cache memory (e.g., a cache memory of the processor 560), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 564 includes a non-transitory computer-readable medium. The memory 564 may store instructions 566. The instructions 566 may include instructions that, when executed by the processor 560, cause the processor 560 to perform the operations described herein. Instructions 566 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 568 can include any electronic circuitry and/or logic circuitry to facilitate direct or indirect communication of data between the processor circuit 550, and other processors or devices. In that regard, the communication module 568 can be an input/output (I/O) device. In some instances, the communication module 568 facilitates direct or indirect communication between various elements of the processor circuit 550 and/or the system 100. The communication module 468 may communicate within the processor circuit 550 through numerous methods or protocols.

External communication (including but not limited to software updates, firmware updates, preset sharing between the processor and central server, or readings from vehicle or environmental sensors) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

The technology described herein may be implemented on manually controlled vehicles or driver-assist vehicles. The technology may be implemented in diverse combinations of hardware, software, and firmware, depending on the implementation or as necessitated by the structures and modules already present in existing vehicles. The system may be employed on vehicles with automatic transmission, manual transmissions, or vehicles with simulated shifting, including continuously variable transmission (CVT), infinitely variable transmission (IVT), hybrid transmissions (e.g., a hybrid vehicle with 4-speed automatic transmission simulating 10gears), and fully electric vehicles.

Accordingly, the logical operations making up the embodiments of the technology described herein may be referred to variously as operations, steps, blocks, objects, elements, components, or modules. Furthermore, it should be understood that these may occur or be arranged in any order, unless explicitly claimed otherwise or a specific order is necessitated by the claim language or by the nature of the component or step.

These and other advantages will be readily apparent to those ordinarily skilled in the art having the benefit of this disclosure.

Methods and embodiments described herein further relate to any one or more of the following paragraphs:
1. A method for mitigating powertrain damage in a vehicle due to liquid intrusion during water fording, the method comprising: in response to an activation signal, initiating a battery cooling fan or engine piston to create pressure in an exhaust of the vehicle to prevent water ingress; and maintaining operation of the battery cooling fan or engine piston until the vehicle exits the water fording event.
2. The method as defined in paragraph 1, initiating the battery cooling fan comprises: initiating an operational speed of the battery cooling fan to generate a positive pressure within a battery pack housing of the vehicle; exhausting air from the battery pack housing to prevent water ingress into the battery pack; and maintaining the battery cooling fan speed for a predetermined duration or until the vehicle exits the water fording event.
3. The method as defined in paragraphs 1 or 2, wherein initiating the engine piston comprises initiating an engine to thereby cause the engine piston to pump air which creates the pressure in the exhaust necessary to prevent water ingress.
4. The method as defined in any of paragraphs 1-3, wherein the activation signal is generated by: detecting, via a vehicle control system, a water fording event based on at least one sensor input indicative of at least partial vehicle submersion in water; and in response to detecting the water fording event, generating the activation signal.
5. The method as defined in any of paragraphs 1-4, wherein the activation signal is generated by: detecting, via a vehicle control system, a water fording event based on vehicle route data obtained using a global positioning system; and in response to detecting the water fording event, generating the activation signal.
6. The method as defined in any of paragraphs 1-5, wherein the activation signal is generated manually via a trigger mechanism actuated by a vehicle occupant.
7. The method as defined in any of paragraphs 1-6, wherein the vehicle is an electric or hybrid vehicle.
8. A system for mitigating powertrain damage in a vehicle due to liquid intrusion during water fording, the system comprising a battery pack housing configured to enclose a battery pack; a battery cooling fan fluidly coupled to the battery pack housing; and a controller operatively connected to the battery cooling fan, the controller configured to: in response to an activation signal, initiate an operational speed of the battery cooling fan to generate a positive pressure within the battery pack housing of the vehicle; exhaust air from the battery pack housing to prevent water ingress into the battery pack; and maintain the battery cooling fan speed for a predetermined duration or until the vehicle exits the water fording event.
9. The system as defined in paragraph 8, wherein the activation signal is generated by: detecting, via a vehicle control system, a water fording event based on at least one sensor input indicative of at least partial vehicle submersion in water, the at least one sensor being operatively connected to the controller; and in response to detecting the water fording event, generating the activation signal.
10. The system as defined in paragraphs 8 or 9, wherein the activation signal is generated by: detecting, via a vehicle control system, a water fording event based on vehicle route data obtained using a global positioning system; and in response to detecting the water fording event, generating the activation signal.
11. The system as defined in any of paragraphs 8-10, wherein the activation signal is generated manually via a trigger mechanism actuated by a vehicle occupant.
12. The system as defined in any of paragraphs 8-11, wherein initiating the operational speed of the battery cooling fan comprises increasing the operational speed of the battery cooling fan to a speed higher than a normal operating speed.
13. The system as defined in any of paragraphs 8-12, wherein the vehicle is an electric or hybrid vehicle.
14. A vehicle, comprising: a battery pack housing configured to enclose a battery pack; a battery cooling fan fluidly coupled to the battery pack housing; and a controller operatively connected to the battery cooling fan, the controller configured to: in response to an activation signal, initiate an operational speed of a battery cooling fan to generate a positive pressure within a battery pack housing of the vehicle; exhaust air from the battery pack housing to prevent water ingress into the battery pack; and maintain the battery cooling fan speed for a predetermined duration or until the vehicle exits the water fording event.
15. The vehicle as defined in paragraph 14, wherein the activation signal is generated by: detecting, via a vehicle control system, a water fording event based on at least one sensor input indicative of at least partial vehicle submersion in water, the at least one sensor being operatively connected to the controller; and in response to detecting the water fording event, generating the activation signal.
16. The vehicle as defined in paragraphs 14 or 15, wherein the activation signal is generated by: detecting, via a vehicle control system, a water fording event based on vehicle route data obtained using a global positioning system; and in response to detecting the water fording event, generating the activation signal.
17. The vehicle as defined in any of paragraphs 14-16, wherein the activation signal is generated manually via a trigger mechanism actuated by a vehicle occupant.
18. The vehicle as defined in any of paragraphs 14-17, wherein the vehicle is an electric or hybrid vehicle.
19. A system for mitigating powertrain damage in a vehicle due to liquid intrusion during water fording, the system comprising: an engine comprising a piston; and a controller operatively connected to the engine, the controller configured to: in response to an activation signal, initiate the piston to pump air that creates pressure in an exhaust of the vehicle to prevent water ingress; and maintain the exhaust pressure until the vehicle exits the water fording event.
20. The system as defined in paragraph 19, wherein the piston pumps the air without combustion inside the piston.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the cargo seat adjustment system. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

The above specification, examples and data provide a complete description of the structure and use of exemplary embodiments of the vehicle door activating system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter. Additionally, sensors external to the vehicle may be employed to provide or supplement any of the sensor data described hereinabove. Alternatively, machine learning algorithms or other AI systems may be used to estimate variables from sparse, noisy, or entwined data streams without departing from the spirit of the present disclosure.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A method for mitigating powertrain damage in a vehicle due to liquid intrusion during water fording, the method comprising:
in response to an activation signal, initiating a battery cooling fan or engine piston to create pressure in an exhaust of the vehicle to prevent water ingress; and
maintaining operation of the battery cooling fan or engine piston until the vehicle exits the water fording event.

2. The method as defined in claim 1, initiating the battery cooling fan comprises:
initiating an operational speed of the battery cooling fan to generate a positive pressure within a battery pack housing of the vehicle;
exhausting air from the battery pack housing to prevent water ingress into the battery pack; and
maintaining the battery cooling fan speed for a predetermined duration or until the vehicle exits the water fording event.

3. The method as defined in claim 1, wherein initiating the engine piston comprises initiating an engine to thereby cause the engine piston to pump air which creates the pressure in the exhaust necessary to prevent water ingress.

4. The method as defined in claim 1, wherein the activation signal is generated by:
detecting, via a vehicle control system, a water fording event based on at least one sensor input indicative of at least partial vehicle submersion in water; and
in response to detecting the water fording event, generating the activation signal.

5. The method as defined in claim 1, wherein the activation signal is generated by:
detecting, via a vehicle control system, a water fording event based on vehicle route data obtained using a global positioning system; and
in response to detecting the water fording event, generating the activation signal.

6. The method as defined in claim 1, wherein the activation signal is generated manually via a trigger mechanism actuated by a vehicle occupant.

7. The method as defined in claim 1, wherein the vehicle is an electric or hybrid vehicle.

8. A system for mitigating powertrain damage in a vehicle due to liquid intrusion during water fording, the system comprising:
a battery pack housing configured to enclose a battery pack;
a battery cooling fan fluidly coupled to the battery pack housing; and
a controller operatively connected to the battery cooling fan, the controller configured to:
in response to an activation signal, initiate an operational speed of the battery cooling fan to generate a positive pressure within the battery pack housing of the vehicle;
exhaust air from the battery pack housing to prevent water ingress into the battery pack; and
maintain the battery cooling fan speed for a predetermined duration or until the vehicle exits the water fording event.

9. The system as defined in claim 8, wherein the activation signal is generated by:
detecting, via a vehicle control system, a water fording event based on at least one sensor input indicative of at least partial vehicle submersion in water, the at least one sensor being operatively connected to the controller; and
in response to detecting the water fording event, generating the activation signal.

10. The system as defined in claim 8, wherein the activation signal is generated by:
detecting, via a vehicle control system, a water fording event based on vehicle route data obtained using a global positioning system; and
in response to detecting the water fording event, generating the activation signal.

11. The system as defined in claim 8, wherein the activation signal is generated manually via a trigger mechanism actuated by a vehicle occupant.

12. The system as defined in claim 8, wherein initiating the operational speed of the battery cooling fan comprises increasing the operational speed of the battery cooling fan to a speed higher than a normal operating speed.

13. The system as defined in claim 8, wherein the vehicle is an electric or hybrid vehicle.

14. A vehicle, comprising:
a battery pack housing configured to enclose a battery pack;
a battery cooling fan fluidly coupled to the battery pack housing; and
a controller operatively connected to the battery cooling fan, the controller configured to:
in response to an activation signal, initiate an operational speed of a battery cooling fan to generate a positive pressure within a battery pack housing of the vehicle;
exhaust air from the battery pack housing to prevent water ingress into the battery pack; and
maintain the battery cooling fan speed for a predetermined duration or until the vehicle exits the water fording event.

15. The vehicle as defined in claim 14, wherein the activation signal is generated by:
detecting, via a vehicle control system, a water fording event based on at least one sensor input indicative of at least partial vehicle submersion in water, the at least one sensor being operatively connected to the controller; and
in response to detecting the water fording event, generating the activation signal.

16. The vehicle as defined in claim 14, wherein the activation signal is generated by:
detecting, via a vehicle control system, a water fording event based on vehicle route data obtained using a global positioning system; and
in response to detecting the water fording event, generating the activation signal.

17. The vehicle as defined in claim 14, wherein the activation signal is generated manually via a trigger mechanism actuated by a vehicle occupant.

18. The vehicle as defined in claim 14, wherein the vehicle is an electric or hybrid vehicle.

19. A system for mitigating powertrain damage in a vehicle due to liquid intrusion during water fording, the system comprising:
an engine comprising a piston; and
a controller operatively connected to the engine, the controller configured to:
in response to an activation signal, initiate the piston to pump air that creates pressure in an exhaust of the vehicle to prevent water ingress; and
maintain the exhaust pressure until the vehicle exits the water fording event.

20. The system as defined in claim 19, wherein the piston pumps the air without combustion inside the piston.
